(19) United States
(12) Patent Application Publication
(10) Pub. No.: US 2017/0358785 A1
(43) Pub. Date: Dec. 14, 2017

(54) POWER SUPPLY DEVICE AND VEHICLE INCLUDING THE SAME

(71) Applicant: Sanyo Electric Co., Ltd., Daito-shi, Osaka (JP)

(72) Inventors: Takayuki Hattori, Hyogo (JP); Hiroyuki Hashimoto, Hyogo (JP); Kazunari Hiraide, Osaka (JP)

(73) Assignee: Sanyo Electric Co., Ltd., Daito-shi, Osaka (JP)

(21) Appl. No.: 15/546,995

(22) PCT Filed: Feb. 24, 2016
(86) PCT No.: PCT/JP2016/000976

§ 371 Date: Jul. 27, 2017

(30) Foreign Application Priority Data
Feb. 27, 2015 (JP) 2015-039361

(51) Int. Cl. H01M 2/10; H01M 2/34; B60L 11/18

(52) U.S. Cl. CPC H01M 2/1077; B60L 11/1864; H01M 2/348; H01M 2/345; H01M 2220/20; H01M 2200/103; H01M 2200/20

(57) ABSTRACT

A secondary battery includes an electrode body, an outer can, a sealing plate, electrode terminals, and a current interrupt device. The electrode terminals includes a first electrode terminal and a second electrode terminal, and are electrically connected to the electrode body through a collector member. The current interrupt device includes a short-circuit part that short-circuits the battery when the internal pressure exceeds a set pressure, and a fuse part disposed in the collector member. The fuse part is disposed close to an upper end corner portion serving as a boundary portion between an upper surface and a side surface of the secondary battery. A binding member includes a protective cover portion that covers the upper end corner portion of the secondary battery, and the protective cover portion includes an upper-surface covering part and a side-surface covering part.

### TECHNICAL FIELD

The present invention relates to a power supply device in which a plurality of secondary batteries capable of charging and discharging are stacked, and to a vehicle including the power supply device.

### BACKGROUND ART

In a power supply device for a vehicle, multiple secondary batteries capable of charging and discharging are connected in series into a battery block, and the output voltage of the battery block is set high to increase power to be supplied to a motor for running the vehicle. This power supply device is discharged by supplying power to the motor in a running state of the vehicle, and is charged by a power generator in regenerative braking of the vehicle. The discharging current of the batteries specifies the driving torque of the motor, and the charging current of the batteries specifies the braking force for regenerative braking. Therefore, it is necessary to increase the discharging current of the batteries in order to increase the driving torque of the motor for accelerating the vehicle, and it is necessary to charge the batteries with a large current in order to increase regenerative braking of the vehicle. Accordingly, the batteries in the power supply device for the vehicle are discharged or charged with a large current. To improve safety in discharging and charging the batteries with a large current, there has been developed a battery including a mechanism that interrupts the current when the internal pressure of the battery abnormally increases, that is, a current interrupt device.

As a battery including such a current interrupt device, for example, there has been proposed a secondary battery including a device that interrupts the current by fusing a contained fuse part when the internal pressure of the battery exceeds a set pressure (see PTL 1). As illustrated in FIG. 14, this secondary battery 101 includes an electrode body 115, a collector plate 116 connected to the electrode body 115, an outer can 111 that contains the electrode body 115, a sealing plate 112 that hermetically seals the outer can 111, an inverting plate 122 having an edge connected to the sealing plate 112 and made of a conductive material, and a connection plate 123 insulated from the sealing plate 112 by an insulating member 124 and having a different polarity. The collector plate 116 has a fuse part 121 to be melted by heat of an overcurrent. The inverting plate 122 normally bulges toward an inner region of the outer can 111, and inverts when the pressure in the battery exceeds the set pressure. In the secondary battery 101, when the internal pressure of the outer can 111 rises, the inverting plate 122 inverts and comes into contact with the connection plate 123, and a short circuit is made inside the secondary battery 101. At this time, inside the battery, the fuse part 121 provided in the collector plate 116 is melted by heat, and this breaks the electrical connection between electrode terminals of the battery and the electrode body 115.

### CITATION LIST

### Patent Literature

PTL 1: Japanese Published Unexamined Patent Application No. 2012-195278

### SUMMARY OF INVENTION

### Technical Problem

The current can be reliably interrupted by fusing of the fuse part contained in the secondary battery by completely fusing and cutting off the fuse part. In an actual secondary battery, however, it is difficult to completely fuse the fuse part in a limited narrow space inside the battery. It is conceivable that a spark will occur at the time of fusing and that a spark will be caused by reconduction resulting from the contact between fused portions.

Particularly when the fuse part is fused in the vehicular power supply device, the current is interrupted and motor driving cannot be performed, but, for example, a hybrid car can run by using the engine. However, it is conceivable that, if engine driving is performed in this state, the fused portions may come into contact with each other inside the secondary battery and a spark may be caused by reconduction. In particular, in the secondary battery mounted in the vehicle, vibration due to driving of the vehicle cannot be completely removed. It is conceivable that the fused portions may be brought into contact with each other by external vibration and a spark may be easily caused by reconduction. From these, the present inventors considered that, in the secondary battery including the current interrupt device for interrupting the current by fusing the fuse part, the occurrence of the spark at the time of fusing and reconduction could not be completely avoided and that it was necessary to take measures to prevent scattering of the spark to the outside of the secondary battery.

The present invention has been made in view of these problems of the related art. An object of the invention is to provide a power supply device that can effectively prevent a spark from scattering to the outside of a secondary battery even if the spark occurs at fused portions and damages an outer can when a fuse part contained in the second battery is fused and reconducted, and a vehicle including the power supply device.

### Solution to Problem and Advantageous Effects of Invention

To achieve the above object, a power supply device according to the present invention includes a battery stack in which a plurality of secondary batteries are stacked, and a binding member that binds the battery stack. Each of the secondary batteries includes an electrode body having a positive electrode and a negative electrode, an outer can having an opening and shaped like a bottomed cylinder to contain the electrode body, a sealing plate that closes the opening of the outer can, a pair of electrode terminals disposed on the sealing plate, and a current interrupt device that operates when an internal pressure of the secondary battery exceeds a set pressure. The pair of electrode terminals include a first electrode terminal insulated from the sealing plate and a second electrode terminal electrically connected to the sealing plate, and are electrically connected to the electrode body through a collector member inside the secondary battery. The current interrupt device includes a short-circuit part that short-circuits the first electrode terminal and the sealing plate when the internal pressure of the secondary battery exceeds the set pressure, and a fuse part provided in the collector member. The fuse part is disposed close to an upper end corner portion serving as a boundary portion between an upper surface and a side surface of the secondary battery, and is fused by an overcurrent in a short-circuit state of the short-circuit part. The binding member includes a protective cover portion located on each side of the battery stack to cover the upper end corner portion of the secondary battery. The protective cover portion includes an upper-surface covering part that covers an upper surface of the upper end corner portion and a side-surface covering part that covers a side surface of the upper end corner portion.

In this description, the up-down direction of the secondary battery is specified in the drawings. The side surface of the second battery refers to a narrow surface on each side of a battery stack in which a plurality of secondary batteries are stacked with wide principal surfaces opposed to each other.

The present invention is effective particularly when the fuse part is located in a region at a direct distance of 2 cm or less from the upper end corner portion. Further, the present invention is more effective when the fuse part is located in a region at a direct distance of 1 cm or less from the upper end corner portion. Preferably, the collector member has a platelike portion, and the fuse part is constituted by a portion having a small cross-sectional area obtained by forming an opening in the platelike portion. The present invention is more effective when the fuse part is located in a region of the collector member between the sealing plate and the electrode body. Further, the present invention is more effective when the platelike portion of the collector member having the fuse part is located parallel to the sealing plate.

According to the power supply device having the above-described structure, the fuse part in the current, interrupt device is located close to the upper end corner portion of the secondary battery, and the binding member that binds the battery stack has the protective cover portion that covers the upper end corner portion of the secondary battery. Hence, even if a spark occurs at fused portions and damages the outer can during fusing and reconduction of the contained fuse part, the spark can be effectively prevented from scattering to the outside of the second battery. In particular, since the protective cover portion includes the upper-surface covering part that covers the upper surface of the upper end corner portion and the side-surface covering part that covers the side surface, the protective cover portion can reliably cover the upper end corner portion of the secondary battery and can effectively prevent scattering of the spark from the upper end corner portion.

In the power supply device of the present invention, the binding member can be a bind bar formed by bending a metal plate having a predetermined thickness. According to the above structure, the binding member can be easily produced at low cost by bending the metal plate.

In the power supply device of the present invention, an insulating member can be provided on an inner surface of the bind bar. According to the above structure, while the binding member is the metal plate, a portion thereof opposed to the battery stack can be insulated and safely used.

In the power supply device of the present invention, the bind bar can include an upper bind bar that covers an upper portion of a side surface of the battery stack and a lower bind bar that covers a lower portion of the side surface of the battery stack, and the upper bind bar can also function as the protective cover portion. According to the structure, since the battery stack is connected by four bind bars, four corners of the battery stack can be bound in an ideal state by the bind bars.

In the power supply device of the present invention, the bind bar can have a body portion opposed to a side surface of the battery stack, and the body portion can cover the entire side surface of the battery stack. According to the above structure, the mechanical strength can be increased by widening the bind bar opposed to the side surface of the battery stack. Moreover, since the side surface of the battery stack is entirely covered, the spark can be reliably prevented from scattering toward the side surface of the battery stack.

In the power supply device of the present invention, the bind bar can have a body portion opposed to a side surface of the battery stack, and the body portion can have an open window. According to the above structure, the weight of the bind bar opposed to the side surface of the battery stack can be reduced, and heat can be effectively dissipated by exposing the side surface of the secondary battery from the open window.

In the power supply device of the present invention, the bind bar can have a horizontal portion that covers at least a part of a bottom surface of the battery stack. According to the above structure, since at least a part of the bottom surface of the battery stack is covered with the horizontal portion, a plurality of stacked secondary batteries can be bound while positioning the bottom surfaces of the secondary batteries, and the vibration-resistant strength can be further increased by further suppressing the relative movement in the up-down direction.

A vehicle according to the present invention includes any of the above-described power supply devices.

According to the vehicle having the above-described structure, while the power supply device having a plurality of secondary batteries is mounted in the vehicle, the binding member that, binds the battery stack is provided with the protective cover portion that covers the upper end corner portion of each of the secondary batteries. Hence, even if a spark occurs at fused portions and damages the outer can at the time of fusing and reconduction of the contained fuse part, the spark can be effectively prevented from scattering to the outside of the second battery. In particular, since the protective cover portion of the binding member includes the upper-surface covering part that covers the upper surface of the upper-end corner portion and the side-surface covering part that covers the side surface, the protective cover portion can reliably cover the upper end corner portion of the secondary battery and can effectively prevent the spark from scattering from the upper end corner portion.

### BRIEF DESCRIPTION OF DRAWINGS

FIG. 1 is an exploded perspective view of a power supply device according to a first embodiment of the present, invention.

FIG. 2 is a perspective view of an assembled battery in the power supply device illustrated in FIG. 1.

FIG. 3 is an exploded perspective view of the assembled battery illustrated in FIG. 2.

FIG. 4 is a vertical cross-sectional view of the assembled battery illustrated in FIG. 2, and illustrates an internal structure of a secondary battery.

FIG. 5 is a cross-sectional view illustrating an operating state of a current interrupt device in the secondary battery illustrated in FIG. 4.

FIG. 6 is an enlarged perspective view of a fuse part provided in a collector member.

FIG. 7 is an enlarged perspective view of another example of the fuse part.

FIG. 8 is a schematic sectional view of an assembled battery according to a second embodiment of the present invention.

FIG. 9 is a vertical cross-sectional view of the assembled battery of FIG. 8.

FIG. 10 is a vertical cross-sectional view of an assembled battery according to a third embodiment of the present invention.

FIG. 11 is a vertical cross-sectional view of an assembled battery according to a fourth embodiment of the present invention.

FIG. 12 is a perspective view of another example of binding members.

FIG. 13 is a perspective view of a further example of the binding members.

FIG. 14 is a schematic sectional view illustrating an example of a current interrupt device in a conventional secondary battery.

### DESCRIPTION OF EMBODIMENTS

### First Embodiment

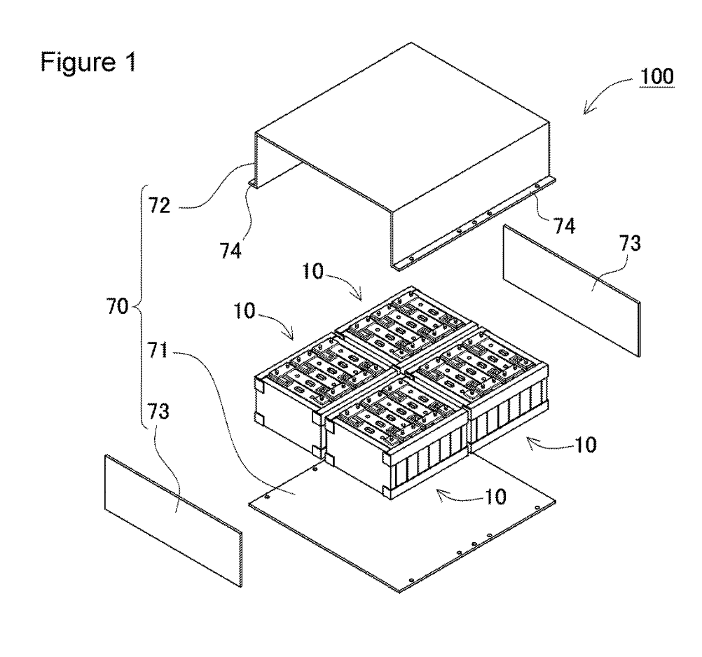

FIGS. 1 to 5 illustrate a power supply device 100 according to a first embodiment of the present invention. The power supply device 100 illustrated in these figures is an example of a vehicle-mounted power supply device. Specifically, the power supply device 100 is mainly mounted in an electrically driven vehicle such as a hybrid car or an electric car, and is used as a power supply that supplies power to a running motor of the vehicle to run the vehicle. The power supply device of the present invention can be used in electrically driven vehicles other than the hybrid car and the electric car, and can also be used for applications requiring large output other than the electrically driven vehicles.

### (Power Supply Device 100)

As illustrated in an exploded perspective view of FIG. 1, the power supply device 100 has an outer shape like a box having a rectangular upper surface. A box-shaped outer case 70 of the power supply device 100 is divided to store a plurality of assembled batteries 10 therein. The outer case 70 includes a lower case 71, an upper case 72, and end face plates 73 connected to both ends of each of the lower case 71 and the upper case 72. The end face plates 73 are connected to both ends of each of the lower case 71 and the upper case 72 to close both ends of the outer case 70. The upper case 72 has flanges 74 projecting outward, and is fixed to the lower case 71 by bolts and nuts through screw holes opening in the flanges 74. The screw holes of the flanges 74 can also be used to fix the power supply device 100. For example, the power supply device 100 is fixed to the vehicle by screwing using the screw holes.

The assembled batteries 10 are fixed at determined positions inside the outer case 70. In the example of FIG. 1, two assembled batteries 10 arranged in the longitudinal direction and two assembled batteries 10 arranged in the lateral direction, that is, a total of four assembled batteries 10 are stored in the outer case 70. The number and layout of the assembled batteries are not limited to those of this example. For example, one assembled battery may be stored in the outer case.

### (Assembled Batteries 10)

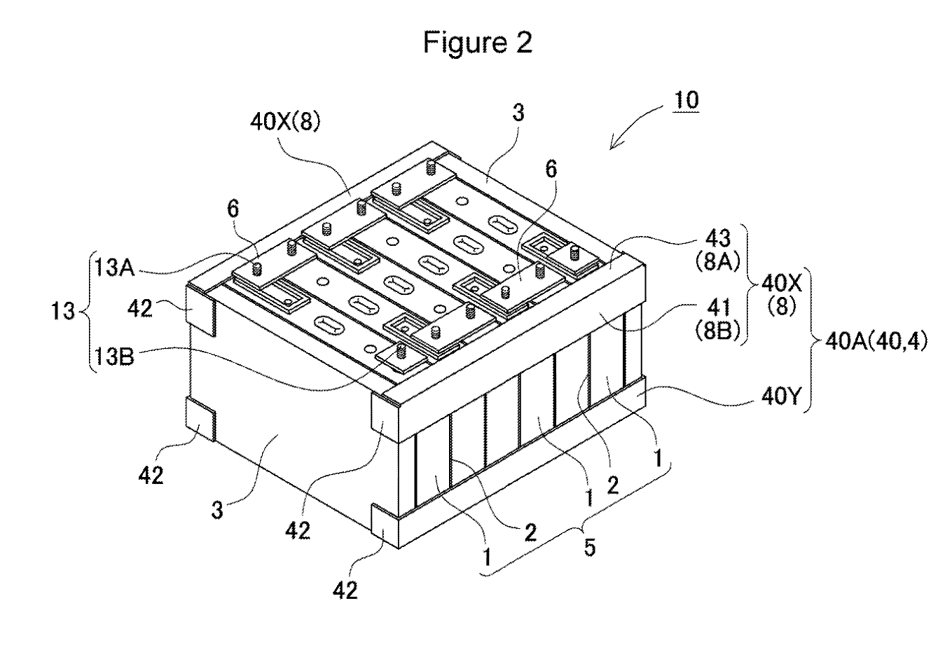

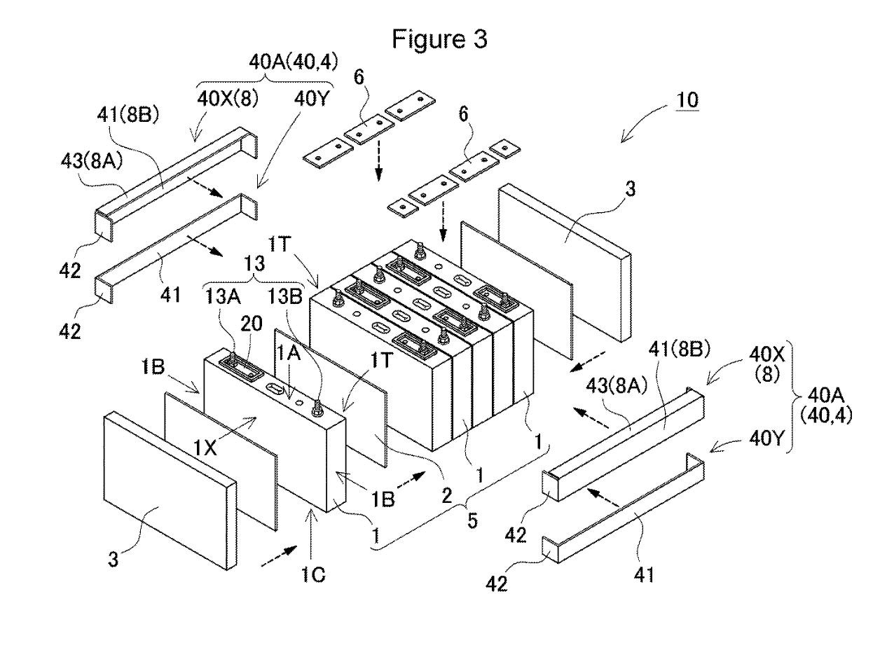

As illustrated in FIGS. 2 and 3, each assembled battery 10 includes a plurality of secondary batteries 1, separators 2 interposed between surfaces of the plurality of stacked secondary batteries 1 to isolate the secondary batteries 1, a pair of end plates 3 disposed on end faces of a battery stack 5 in a stacking direction in which the plurality of secondary batteries 1 and the separators 2 are alternately stacked, and a plurality of metallic binding members 4 disposed on a side surface or an upper surface of the battery stack 5 to bind the end plates 3. The assembled battery 10 is also fixed to the lower case 71. For example, bottom surfaces of the secondary batteries 1 are fixed onto the lower case 71 by adhesion using an adhesive.

The lower case 71 also functions as a cooling plate that cools the battery stack 5. That is, heat generated by the secondary batteries 1 is thermally conducted to the lower case 71 to promote heat dissipation by thermally bonding the bottom surfaces of the secondary batteries 1 to the lower case 71. A cooling pipe for circulating a refrigerant may be disposed on a lower surface or an inner side of the lower case 71. The separators 2 may have grooves through which a cooling gas is passed to cool the secondary batteries 1.

### (Battery Stack 5)

In each assembled battery 10, a plurality of secondary batteries 1 are stacked with insulating separators 2 interposed therebetween to form a battery stack 5, a pair of end plates 3 are disposed on both end faces of the battery stack 5, and the pair of end plates 3 are connected by binding members 4. In the assembled battery 10 illustrated in these figures, the separators 2 for insulating the adjacent secondary batteries 1 are interposed between stacking surfaces of the secondary batteries 1, and the secondary batteries 1 and the separators 2 are alternately stacked to constitute the battery stack 5.

In the assembled battery, the separators do not always need to be interposed between the secondary batteries. For example, the separators can be omitted by insulating the adjacent second batteries by means of a method of forming outer cans of the secondary batteries of an insulating material such as resin, or a method of covering outer peripheries of the outer cans of the secondary batteries with heat-shrinkage tubes, insulating sheets, or an insulating paint. Particularly in a structure that adopts a method of cooling the battery stack through a cooling pipe cooled by, for example, a refrigerant, without using an air cooling method of cooling the secondary batteries by forcibly blowing cooling air between the secondary batteries, it is not always necessary to interpose the separators between the secondary batteries.

### (Secondary Batteries 1)

As illustrated in FIG. 3, the secondary batteries 1 are square batteries having an outer shape that is smaller in thickness than in width. The secondary batteries 1 are chargeable and dischargeable batteries such as lithium-ion secondary batteries, nickel-hydrogen secondary batteries, or nickel-cadmium secondary batteries. Particularly when lithium-ion secondary batteries are used as the secondary batteries 1, it is possible to increase the charging capacity with respect to the total volume or mass of the secondary batteries.

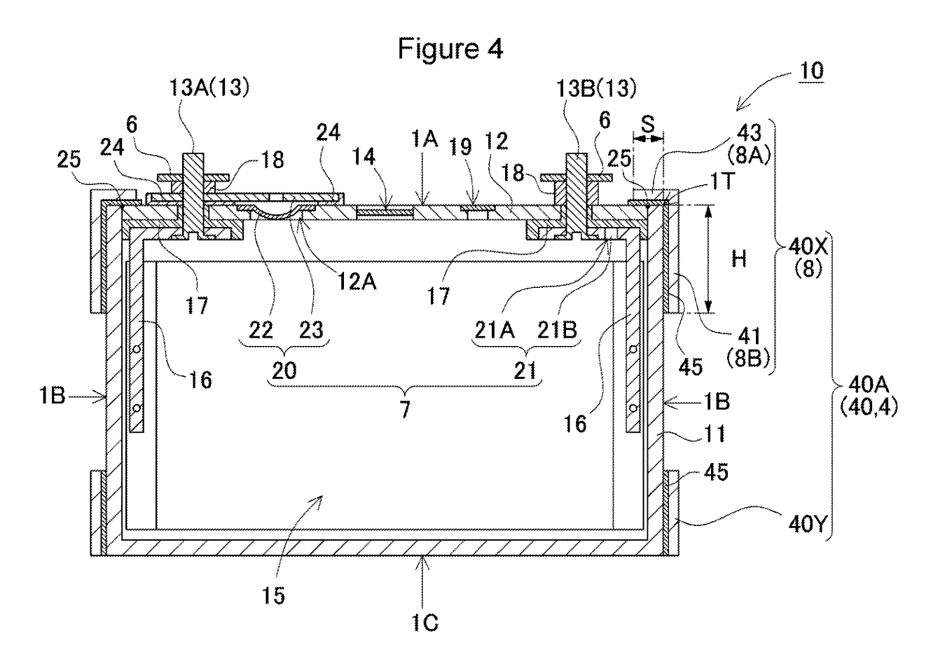

As illustrated in FIG. 4, each of the secondary batteries 1 includes an electrode body 15 having a positive electrode and a negative electrode, an outer can 11 shaped like a bottomed cylinder having an opening in one surface and containing the electrode body 15, a sealing plate 12 that closes the opening of the outer can 11, and a pair of electrode terminals 13 disposed at both ends of the sealing plate 12. The positive electrode and the negative electrode of the electrode body 15 are helically wound with a separator interposed therebetween, are pressed to a predetermined thickness, and are inserted in the outer can 11. The outer can 11 is shaped like a rectangular cylinder having a closed bottom and both opposed wide surfaces, and is open upward in the figure. The outer can 11 having this shape is produced by pressing a metal plate made of, for example, aluminum or an aluminum alloy. The opening of the outer can 11 is closed by laser-welding the flat sealing plate 12 formed by pressing a metal plate.

The sealing plate 12 has a gas discharge valve 14 between the pair of electrode terminals 13. The gas discharge valve 14 opens to discharge inner gas when the internal pressure of the outer can 11 rises to a pressure higher than or equal to a predetermined pressure. By opening the gas discharge valve 14, the rise of the internal pressure of the outer can 11 can be suppressed. The gas discharge valve 14 is preferably disposed at almost, the longitudinal center of the sealing plate 12. Thus, even if the adjacent secondary batteries 1 are stacked while being alternately reversed in the lateral direction, the gas discharge valve 14 can be always aligned with the center of the sealing plate 12. Further, the sealing plate 12 has a liquid injection portion 19 adjacent to the gas discharge valve and allowing injection of an electrolyte therethrough. The secondary battery 1 is produced by inserting the electrode body 15 in the outer can 11, hermetically sealing the opening of the outer can 11 with the sealing plate 12, and then injecting an electrolyte (not illustrated) from the liquid injection portion 19.

The pair of electrode terminals 13 includes a first electrode terminal 13A insulated from the sealing plate 12 and a second electrode terminal 13B electrically connected to the sealing plate 12. The pair of electrode terminals 13 are fixed to determined positions on the sealing plate 12 with gaskets 17 interposed therebetween. The first electrode terminal 13A is connected to the sealing plate 12 in an insulated state with the gasket 17 interposed therebetween. The second electrode terminal 13B is connected to the sealing plate 12 with the gasket 17 interposed therebetween, and is electrically connected to an upper surface side of the sealing plate 12 with a metallic fixed member 18, which is fixed to the second electrode terminal 13B, interposed therebetween. Inside the secondary battery 1, the positive and negative electrode terminals 13 fixed to the sealing plate 12 are electrically connected to the electrode body 15 with collector members 16 interposed therebetween. In the secondary battery 1, the second electrode terminal 13B connected to the sealing plate 12 and the outer can 11 serves as a positive terminal, and the first electrode terminal 13A serves as a negative terminal.

### (Current Interrupt Device 7)

To avoid a thermal runaway, for example, due to overcharging, each of the secondary batteries 1 includes a current interrupt device 7 that breaks electric connection between the electrode body 15 and the second electrode terminal 13B in response to the rise of the internal pressure of the outer can 11. The illustrated current interrupt device 7 includes a short-circuit part 20 that short-circuits the first electrode terminal 13A and the sealing plate 12 when the internal pressure of the secondary battery 1 exceeds the set pressure, and a fuse part 21 provided in the collector member 16 connected to the second electrode terminal 13B. In the current interrupt device 7, in a state in which the internal pressure of the battery exceeds the set pressure and the short-circuit part 20 makes a short circuit, the fuse part 21 is fused by an overcurrent flowing through the fuse part 21. As a result, the electrical connection between the electrode body 15 and the second electrode terminal 13B is broken and the current is interrupted.

### (Short-Circuit Part 20)

When the internal pressure of the secondary battery 1 exceeds the set pressure, for example, owing to overcharging, the short-circuit part 20 serves to induce a short circuit so that a large current flows through the fuse part 21. The short-circuit part 20 illustrated in FIG. 3 includes an inverting plate 22 fixed to the sealing plate 12 and made of a conductive material and a metallic connection plate 23 disposed on the upper side of the sealing plate 12 to be opposed to the inverting plate 22.

### (Inverting Plate 22)

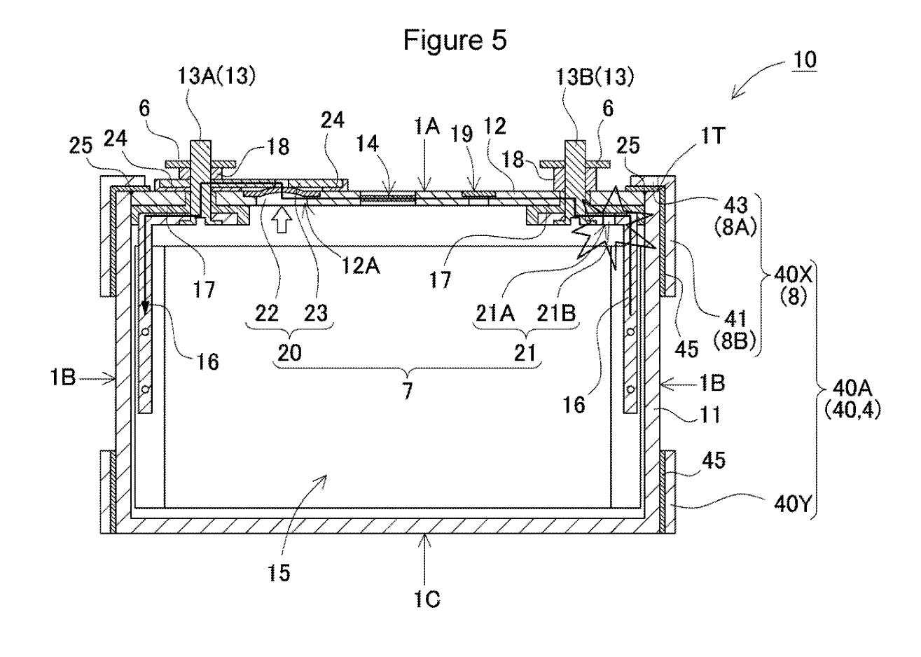

As illustrated in FIG. 4, the inverting plate 22 is attached at a short-circuit hole 12A opening in the sealing plate 12, for example, by welding. An outer peripheral edge portion of the inverting plate 22 is electrically connected to the sealing plate 12, and a center portion of the inverting plate 22 is curved to project toward the inside of the outer can 11. When overcharging occurs in the secondary battery 1 and the internal pressure of the secondary battery 1 exceeds the set pressure, as illustrated in FIG. 5, the inverting plate 22 inverts and bulges upward, that is projects in a direction apart from the electrode body 15 and comes into contact with the connection plate 23, so that a short-circuit is induced.

While one inverting plate 22 is provided in the short-circuit part 20 of this example, a plurality of inverting plates may be stacked. In a short-circuit part including a plurality of stacked inverting plates, when the inverting plates are made different in thickness and set inverting pressure, it is possible to more smoothly respond to the rise of the internal pressure of the battery and to continue the fuse function of the fuse part while maintaining a short circuit of one of the inverting plates even when the other inverting plate is fused by heat.

The connection plate 23 is disposed on the upper surface of the sealing plate 12 with an insulating portion 24 interposed therebetween, and is connected to the sealing plate 12 in an insulated state. The connection plate 23 is electrically connected to the first electrode terminal 13A. Specifically, the first electrode terminal 13A is passed through a hole opening in a part of the connection plate 23, and the connection plate 23 and the first electrode terminal 13A are electrically connected through the fixed member 18 fixed to the first electrode terminal 13A on the upper side of the connection plate 23.

### (Fuse Part 21)

The fuse part 21 is to be fused and cut off by heat generated by an overcurrent flowing through the battery in a short-circuit state of the short-circuit part 20, and is disposed in a conduction path of the current at the time of a short circuit. The fuse part 21 illustrated in FIG. 3 is disposed in the collector member 16 connected to the second electrode terminal 13B. The fuse part 21 provided in the collector member 16 is to be fused by an overcurrent flowing through the collector member 16 in the short-circuit state of the short-circuit part 20.

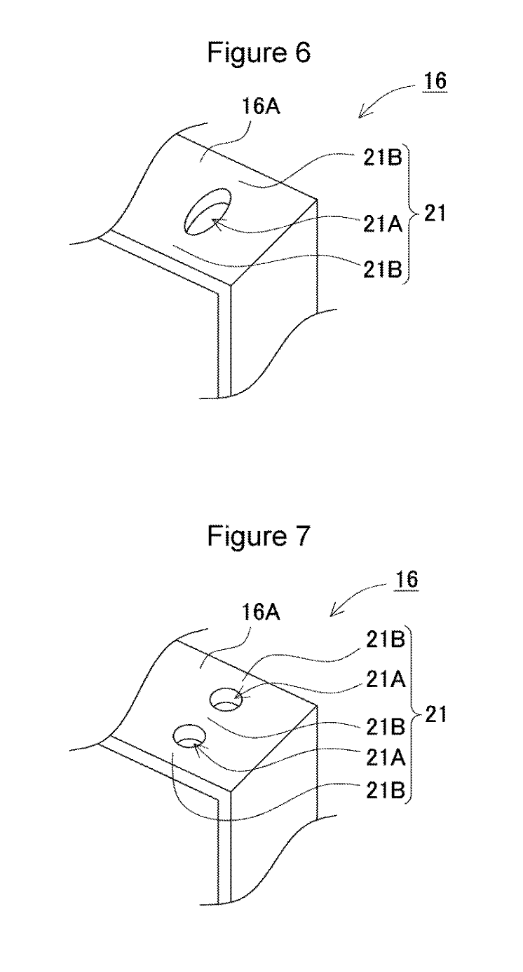

The fuse part 21 illustrated in FIG. 3 is constituted by a fuse hole 21A opening in the collector member 16, and specifically, is constituted by a connecting portion 21B on both sides of the fuse hole 21A opening in a platelike portion 16A of the collector member 16, as illustrated in FIG. 6. The connecting portion 21B has a cross-sectional area that is reduced by the opening of the fuse hole 21A, and the electric resistance thereof locally increases. Thus, the connecting portion 21B functions as a fuse that interrupts the current by being fused by heat generated by a large current flowing in the short circuit of the secondary battery 1. In the collector member 16 illustrated in FIG. 6, one fuse hole 21A is open in the platelike portion 16A, and the connecting portion 21B is located on both sides of the fuse hole 21A. In the collector member 16, as illustrated in FIG. 7, a plurality of (two in FIG. 7) fuse holes 21A can open in the platelike portion 16A and a connecting portion 21B can be located in a portion between the fuse holes 21A and in both side portions of the platelike portion 16A. While the planar shape of the fuse hole 21A is elliptic or circular in FIGS. 6 and 7, the shape, such as an oval shape, a rectangular shape, a polygonal shape, an arc shape, or a slit shape, and layout of the fuse hole 21A can be changed variously. Although not illustrated, in the fuse part, cutouts can be provided in both side portions of the platelike portion and a narrow portion in a center portion of the platelike portion can serve as a connecting portion, a cutout can be provided in one side portion of the platelike portion and the other remaining side portion can serve as a connecting portion, or a cutout can be provided on a side portion of the platelike portion and a fuse hole can be provided in a center portion of the platelike portion so that an obtained narrow portion serves as a connecting portion.

In the above-described fuse part 21, the connecting portion 21B is fused and cut off in the region where the fuse hole 21A or the cutout are provided. This electrically separates the platelike portion 16A of the collector member 16 and interrupts the current. As illustrated in FIG. 3, the fuse part 21 is disposed in a region on an upper side of the electrode body 15 stored in the outer can 11 and on an outer side of the electrode terminal 13. That is, the fuse part 21 is disposed close to an upper end corner portion 1T serving as a boundary portion between the upper surface and the side surface of the secondary battery 1.

The fuse part 21 is preferably obtained by forming an opening in the platelike portion 16A of the collector member 16. Further, the thickness of the sealing plate 12 is preferably more than or equal to double the thickness of the platelike portion 16A of the collector member 16.

In the current interrupt device 7 illustrated in FIG. 3, the fuse part 21 is provided in the collector member 16 connected to the second electrode terminal 13B. This structure can reduce the adverse effect on the short-circuit part 20 resulting from the spark caused during fusing and reconduction of the fuse part 21 because the short-circuit part 20 and the fuse part 21 are arranged apart from each other. However, the fuse part, can be provided in the collector member connected to the first electrode terminal.

In the above-described current interrupt device 7, when the internal pressure of the secondary battery 1 becomes higher than or equal to the set pressure, as illustrated in FIG. 5, the inverting plate 22 is pushed up by the internal pressure, and is thereby deformed and inverted. When the inverting plate 22 is inverted and comes into contact with the connection plate 23, the inverting plate 22 and the connection plate 23 are conductively connected and the short-circuit part 20 makes a short circuit. When the short-circuit part 20 makes the short circuit, a large current flows inside the secondary battery 1 along a path shown by a bold line arrow in FIG. 5. At this time, the fuse part 21 in the conduction path is heated, melted, and cut off by the Joule heat due to the large current, and this interrupts the current. Thus, when the internal pressure of the second battery 1 abnormally rises, the current flowing through the secondary battery 1 is interrupted to ensure safety of the secondary battery 1.

As illustrated in FIG. 3, the above-described secondary batteries 1 are stacked into the battery stack 5 in such a posture that wide surfaces serving as principal surfaces 1X are opposed to each other and that upper surfaces 1A thereof are flush with one another and side surfaces 1B thereof are flush with one another. The plurality of secondary batteries 1 stacked to constitute the battery stack 5 are connected in series with the adjacent positive and negative electrode terminals 13 connected by bus bars 6. When the adjacent secondary batteries 1 are connected in series, the output voltage and output of the assembled battery 10 can be increased. In the assembled battery, however, the adjacent secondary batteries can be connected in parallel or can be connected in a multi-serial parallel manner by combination of serial connection and parallel connection.

In the assembled battery 10 in which the secondary batteries 1 are connected in series, as illustrated in the perspective views of FIGS. 2 and 3, the secondary batteries 1 are stacked in such a posture that the positive and negative electrode terminals 13 of the adjacent secondary batteries 1 are close to each other, in other words, in such a posture that the secondary batteries 1 are alternately reversed in the lateral direction. This can reduce the size of the bus bars 6 that connect the electrode terminals 13. In this structure, the fuse parts 21 contained in the secondary batteries 1 are different in position between the adjacent secondary batteries 1.

### (Separators 2)

The secondary batteries 1 are constituted by the metallic outer cans 11. The secondary batteries 1 hold the insulating separators 2 therebetween to prevent a short, circuit between the outer cans 11 of the adjacent secondary batteries 1. The separators 2 are spacers that allow the adjacent secondary batteries 1 to be stacked while being electrically and thermally insulated from each other. The separators 2 are made of an insulating material such as resin, and are disposed between the adjacent secondary batteries 1 to insulate the adjacent secondary batteries 1.

### (End Plates 3)

A pair of end plates 3 are disposed on both end surfaces of the battery stack 5 in which the secondary batteries 1 and the separators 2 are alternately stacked, and the pair of end plates 3 bind the battery stack 5. The end plates 3 are made of a material that exhibits a sufficient strength, for example, metal. The end plates 3 have fixing structures to be fixed to the lower case 71 illustrated in FIG. 1. Alternatively, the end plates may be made of resin, and further, the resin end plates may be reinforced by members made of a metal material.

### (Binding Members 4)

As illustrated in FIGS. 2 to 5, the binding members 4 are disposed on the side surfaces and the upper surface of the battery stack 5 with the end plates 3 stacked on both ends, and are each fixed at both ends to the pair of end plates 3 to bind the battery stack 5. The illustrated binding members 4 are provided as bind bars 40 each obtained by bending a metal plate of a predetermined thickness into a predetermined shape. These bind bars 40 can be made of a material having a sufficient strength, for example, a metal plate of iron, and preferably a steel plate. By thus using the bind bars 40 each formed by bending the metal plate as the binding members 4, the cost can be reduced.

The binding members 4 serving as the bind bars 40 extend in the stacking direction of the battery stack 5, and are each fixed at. both ends to the pair of end plates 3. Each of the bind bars 40 has a body portion 41 disposed along the side surface of the battery stack 5, and connecting pieces 42 disposed at both ends of the body portion 41 and fixed to the end plates 3. Bind bars 40A illustrated in FIGS. 2 to 5 are disposed opposed to upper portions and lower portions of side surfaces of the battery stack 5 and the end plates 3. That is, the pair of end plates 3 are bound by four bind bars 40A. The four bind bars 40A include two upper bind bars 40X disposed on the upper portions of the side surfaces of the battery stack 5 and two lower bind bars 40Y disposed on the lower portions of the side surfaces of the battery stack 5.

Each of the upper bind bars 40X has an L-shaped cross section defined by connecting pieces 42 at both ends of a body portion 41 of a predetermined width and a horizontal portion 43 at an upper end of the body portion 41 to cover the upper surface of the battery stack 5. In each of the upper bind bars 40X illustrated in FIG. 4, the body portion 41 is extended upward and the extended portion is bent onto the upper surface of the battery stack 5 to form the horizontal portion 43. The horizontal portion 43 is bent substantially perpendicularly to the body portion 41 to take a horizontal posture along the upper surfaces of the secondary batteries 1. The horizontal portion 43 of the upper bind bar 40X serves as a holding portion for holding the upper surface of the battery stack 5. As illustrated in FIG. 3, each of the lower bind bars 40Y has connecting pieces 42 at both ends of a body portion 41 having a predetermined width.

The connecting pieces 42 at both ends of the body portion 41 are bent perpendicularly to the body portion 41 to be in surface contact with outer side surfaces of the end plates 3. Although not illustrated, both ends of each bind bar 40 are fixed to the end plates 3 by connectors such as setscrews, are fixed to the end plates 3 by a retaining structure, or are fixed to the end plates 3 by bonding or welding. In each bind bar 40 illustrated in FIGS. 2 and 3, the connecting pieces 42 are formed by bending both ends of the bind bar 40, and can be fixed to the outer side surfaces of the end plates 3 by the connecting pieces 42. However, the bind bar does not always need to have the connecting pieces at both ends. A bind bar having no connecting piece can be fixed by screwing connectors, such as setscrews, penetrating both ends of the bind bar into the side surfaces of the end plates or penetrating the connectors through the end plates in the up-down direction or the right-left direction. This structure can shorten the total length of the assembled battery.

The binding members 4 further include protective cover portions 8 that cover upper end corner portions 1T at boundaries of the upper surfaces 1A and the side surfaces 1B of the secondary batteries 1. The protective cover portions 8 are disposed to cover the upper end corner portions 1T of the secondary batteries 1 close to the fuse parts 21 contained in the outer cans 11. In each illustrated secondary battery 1, since the fuse part 21 is provided in the collector member 16 that connects the second electrode terminal 13B at the end of the sealing plate 12 and the electrode body 15, the protective cover portion 8 is disposed to cover an edge where the second electrode terminal 13B is disposed in a connecting portion between the sealing plate 12 and the outer can 11. In the binding member 4 of this example, the upper bind bar 40X also functions as the protective cover portion 8.

The protective cover portion 8 illustrated in FIG. 4 includes an upper-surface covering part 8A that covers an upper surface of the upper end corner portion 1T and a side-surface covering part 8B that covers a side surface of the upper end corner portion 1T. That is, in the upper bind bar 40X illustrated in FIG. 4, the body portion 41 covering the upper portion of the side surface of the battery stack 5 functions as the side-surface covering part 8B of the protective cover portion 8, and the horizontal portion 43 covering the upper surface of the battery stack 5 functions as the upper-surface covering part 8A of the protective cover portion 8.

When a spark occurs inside the secondary battery 1, a portion near the joint portion between the opening of the outer can 11 and the sealing plate 12 is most subject to breakage. Therefore, the shape and size of the protective cover portion 8 are such as to cover a region provided near the upper end corner portion 1T of the secondary battery 1 and including at least a welded portion 25 between the opening of the outer can 11 and the edge of the sealing plate 12. In the illustrated secondary battery 1, the boundary portion is welded at the opening of the outer can 11 in a state in which the outer peripheral edge of the sealing plate 12 is fitted inside the edge of the opening of the outer can 11. Therefore, in the secondary battery 1, the welded portion 25 between the outer can 11 and the sealing plate 12 is provided on the upper surface of the secondary battery 1. In the protective cover portion 8 illustrated in FIG. 4, the welded portion 25 inside the opening edge of the outer can 11 is covered with the upper-surface covering part 8A covering the upper surface of the upper end corner portion 1T. The upper-surface covering part 8A preferably extends to a position that is close to the electrode terminal 13, but is out of contact with the electrode terminal 13, and covers the upper surface of the upper end corner portion 1T. Therefore, a length (S) of the secondary battery 1 in the width direction, along which the upper-surface covering part 8A covers the upper surface of the upper end corner portion 1T, is larger than the thickness of the outer can 11 and is 2 mm or more, and preferably 5 mm or more. A length (H) in the vertical direction, along which the side-surface covering part 8B covers the side surface of the upper end corner portion 1T, is 1 cm or more, and preferably 3 cm or more.

In the secondary battery, however, the welded portion does not always need to be provided on the upper surface. Although not illustrated, the boundary portion can also be welded in a state in which the outer peripheral edge of the sealing plate is in contact with the opening edge of the opening of the outer can. In this secondary battery, a welded portion between the outer can and the sealing plate is provided on an outer peripheral surface (side surface and principal surface) of the secondary battery along the outer peripheral edge of the sealing plate. In the secondary battery having this structure, the side-surface covering part covering the side surface of the upper end corner portion covers the welded portion outside the opening edge of the outer can.

In the assembled battery 10 in which the plurality of secondary batteries 1 are connected in series, as described above, the adjacent secondary batteries 1 are stacked in such a posture to be alternately reversed in the lateral direction to connect the adjacent positive and negative electrode terminals 13 by the bus bars 6 in the shortest distance. For this reason, the positions of the fuse parts 21 contained in the secondary batteries 1 alternately differ between the adjacent secondary batteries 1. Therefore, in this assembled battery 10, as illustrated in FIGS. 2 to 4, the protective cover portions 8 are disposed on both sides of the battery stack 5 to cover the upper end corner portions 1T of the secondary batteries 1. Thus, in any of the secondary batteries 1, the upper end corner portion 1T close to the fuse part 21 is covered with the protective cover portion 8. Even if a spark occurs inside the battery, the protective cover portion 8 suppresses scattering of the spark to the outside of the battery. This can improve safety.

### (Insulating Member 45)

The assembled battery 10 illustrated in FIG. 4 has insulating members 45 on inner surfaces of the bind bars 40. The insulating members 45 insulate the metallic bind bars 40 and the outer can 11 of each secondary battery 1, and, for example, insulating sheets, insulating plates, or an insulating paint can be used. In particular, the insulating members 45 on the inner surfaces of the protective cover portions 8 are each preferably constituted by a sheet material or a plate material made of a heat-resistant or flame-resistant resin, and this can reduce breakage and adverse effects due to the spark. The insulating members 45 are preferably provided all over the inner surfaces of the bind bars 40 to insulate the surfaces opposed to the battery stack 5. In the illustrated assembled battery 10, the insulating members 45 are disposed on the inner surfaces of the upper bind bars 40X and the inner surfaces of the lower bind bars 40Y. Some of the separators 2 disposed between the secondary batteries 1 can also function as the insulating members 45. In the secondary battery in which the outer can and the surface of the sealing plate are covered with, for example, a heat-shrinkage tube, an insulating sheet, or an insulating point, as described above, the insulating members on the inner surfaces of the bind bars can be omitted.

In the above-described embodiment, the binding members 4 are constituted by four bind bars 40A, the upper bind bars 40X bind the upper portions of the side surfaces of the battery stack 5, and the lower bind bars 40Y bind the lower portions of the battery stack 5. Although not illustrated, according to this structure, in an air-cooled power supply device that cools secondary batteries by forcibly blowing cooling air between the secondary batteries, the cooling air can be passed and blown through ventilations defined by gaps serving between the upper bind bars and the lower bind bars. However, in the present invention, the binding members 4 on each side of the battery stack 5 can also be constituted by one bind bar 40B.

### Second Embodiment

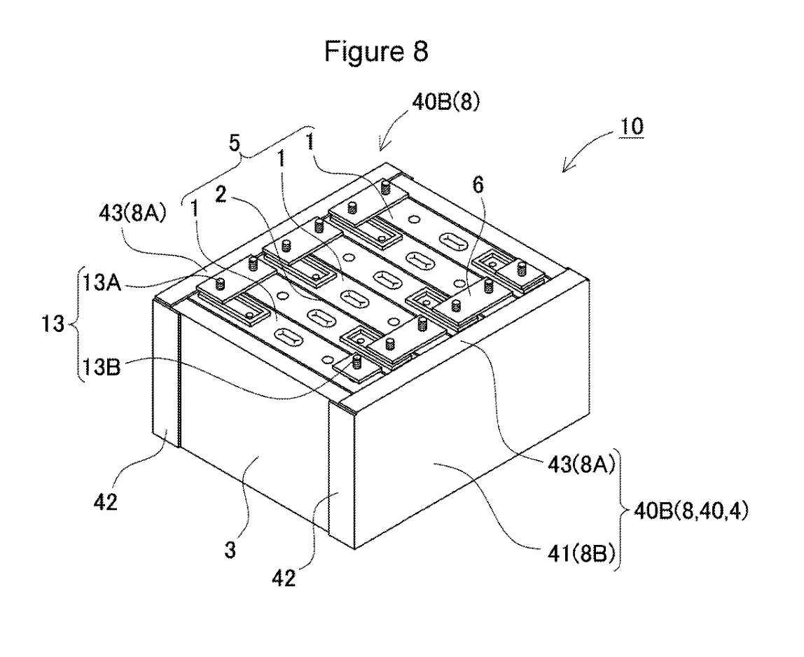

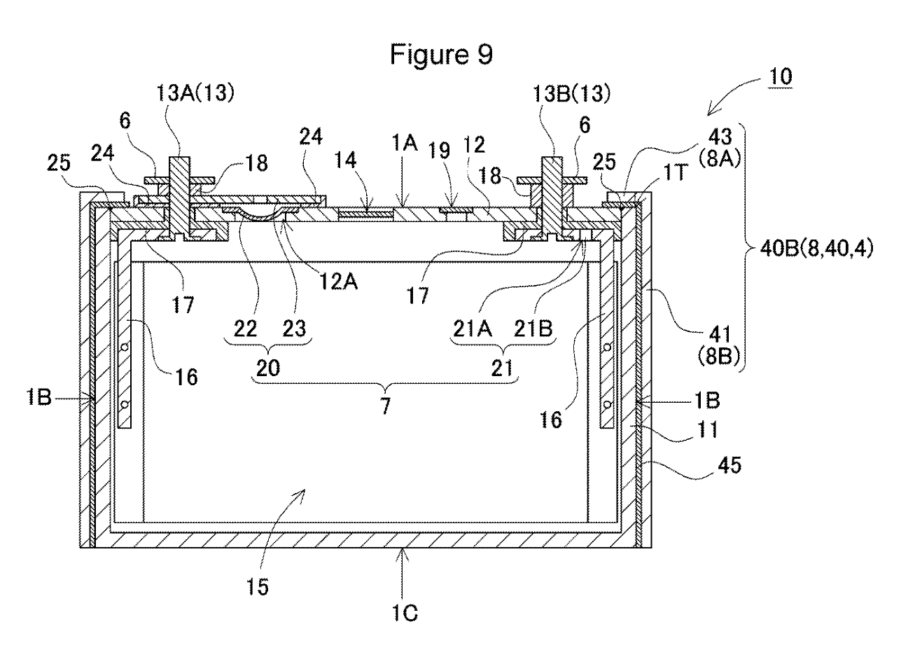

In an assembled battery 10 illustrated in FIGS. 8 and 9, bind bars 40B include their respective body portions 41 opposed to side surfaces of a battery stack 5, and the body portions 41 cover the entire side surfaces of the battery stack 5. The illustrated bind bars 40B each have an L-shaped cross section defined by connecting pieces 42 at both ends of each of the body portions 41 having such a width as to cover the entire side surfaces of the battery stack 5 and horizontal portions 43 at upper ends of the body portions 41 to cover an upper surface of the battery stack 5. The bind bars 40B also function as protective cover portions 8 that cover upper end corner portions 1T of secondary batteries 1. That is, the body portions 41 covering upper portions of the side surfaces of the battery stack 5 function as side-surface covering parts 8B of the protective cover portions 8, and the horizontal portions 43 covering the upper surface of the battery stack 5 function as upper-surface covering parts 8A of the protective cover portions 8. Further, the bind bars 40B have insulating members 45 all over inner surfaces thereof to cover the entire side surfaces and both end portions of the upper surface of the battery stack 5. In the bind bars 40B having this structure, the body portions 41 opposed to the side surfaces of the battery stack 5 are made wide, and this can increase the mechanical strength. Also, the side surfaces of the battery stack 5 are entirely covered, and this can reliably prevent scattering of the spark toward the side surfaces of the battery stack 5.

Alternatively, the binding members 4 can be configured to cover at least a part of the bottom surface of the battery stack 5. For example, the binding members 4 can cover corner portions on the bottom side of the battery stack 5 by providing horizontal portions 43 at lower ends of the bind bars 40.

### Third Embodiment

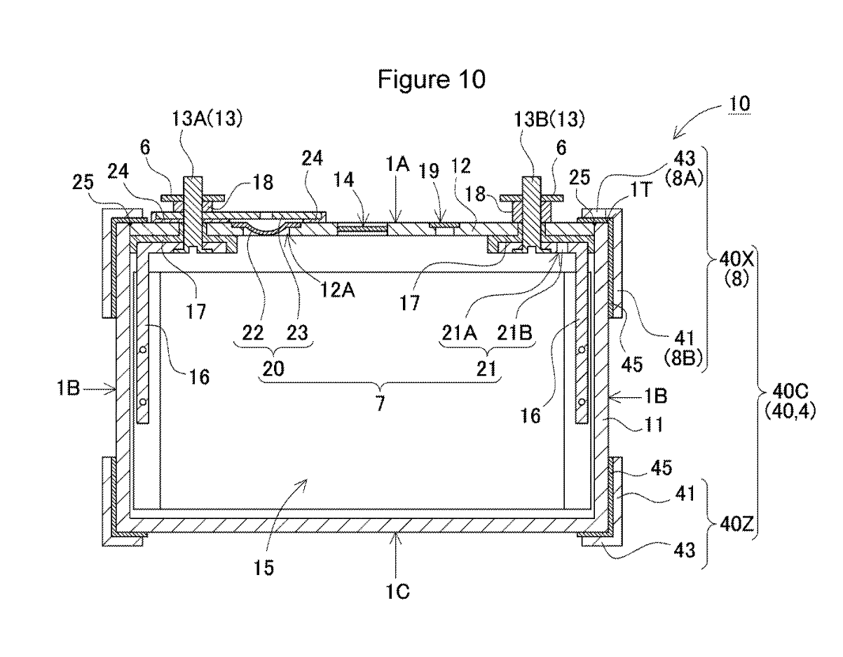

Bind bars 40C illustrated in FIG. 10 include two upper bind bars 40X disposed at corner portions on an upper side of a battery stack 5 and two lower bind bars 40Y disposed at corner portions on a lower side of the battery stack 5. The upper bind bars 40X each have an L-shaped cross section defined by connecting pieces 42 at both ends of each of body portions 41 having a predetermined width and horizontal portions 43 at upper ends of the body portions 41 to cover the upper surface of the battery stack 5, similarly to the above-described upper bind bars 40X. The upper bind bars 40X also function as protective cover portions 8. The lower bind bars 40Z each have an L-shaped cross section defined by connecting pieces 42 at both ends of each of body portions 41 having a predetermined width and horizontal portions 43 at lower ends of the body portions 4 to cover a bottom surface of the battery stack 5. The horizontal portions 43 are bent substantially perpendicularly to the body portions 41 to take a horizontal posture along bottom surfaces 1C of secondary batteries 1. In the four bind bars 4C at four corner portions of the battery stack 5, the body portions 41 are disposed on both sides of the battery stack 5 to prevent the horizontal movement of the secondary batteries 1, and the horizontal portions 43 are disposed on the upper and lower sides of the battery stack 5 to prevent the up-down movement of the secondary batteries 1.

### Fourth Embodiment

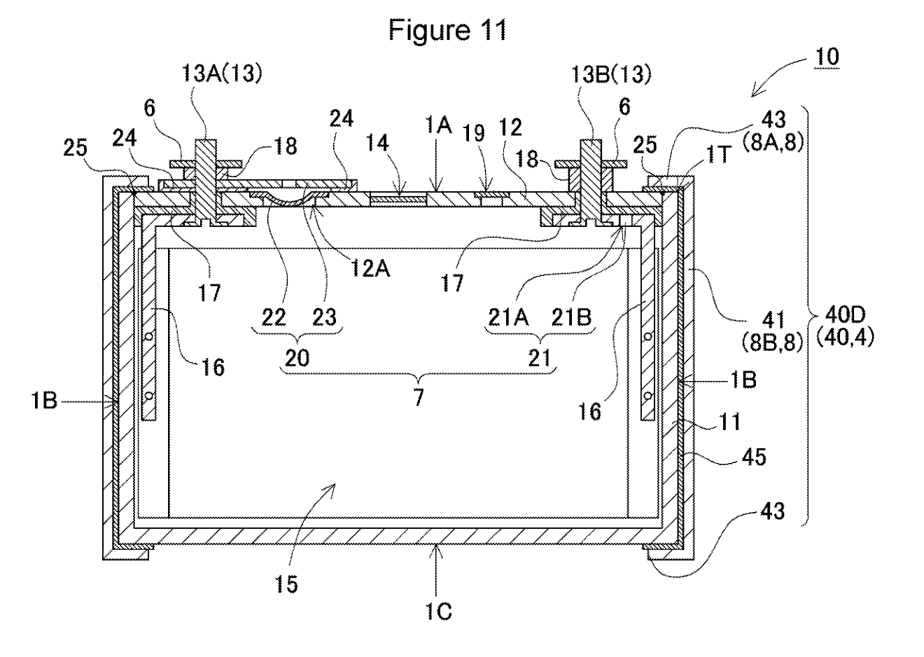

Bind bars 40D illustrated in FIG. 11 each have an angular U-shaped cross section defined by horizontal portions 43 at upper ends and lower ends of body portions 41 covering the entire side surfaces of the battery stack 5 to cover an upper surface and a lower surface of the battery stack 5. In the bind bars 40D, the body portions 41 and the horizontal portions 43 at the upper ends of the body portions 41 constitute protective cover portions 8 that cover upper end corner portions 1T of secondary batteries 1. That is, the body portions 41 covering the side surfaces of the battery stack 5 function as side-surface covering parts 8B of the protective cover portions 8, and the horizontal portions 43 covering the upper surface of the battery stack 5 function as upper-surface covering parts 8A of the protective cover portions 8. In the bind bars 40D having this structure, the body portions 41 opposed to the side surfaces of the battery stack 5 are made wide, and this can increase the mechanical strength. Moreover, the body portions 41 cover the entire side surfaces of the battery stack 5, and this can reliably prevent scattering of the spark toward the side surfaces of the battery stack 5. In the bind bars 40D disposed on both side surfaces of the battery stack 5 and having the angular U-shaped cross section, the body portions 41 are disposed on both sides of the battery stack 5 to prevent horizontal movement of the secondary batteries 1 and the horizontal portions 43 are disposed on the upper and lower sides of the battery stack 5 to prevent up-down movement of the secondary batteries 1.

### Fifth and Sixth Embodiments

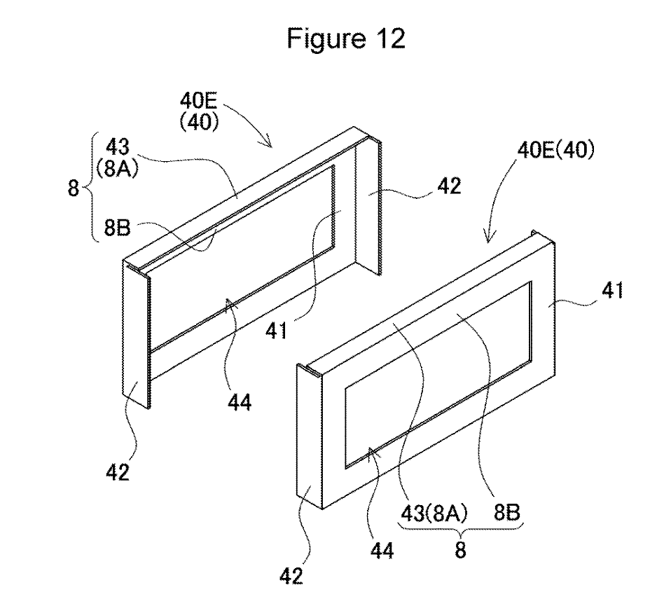

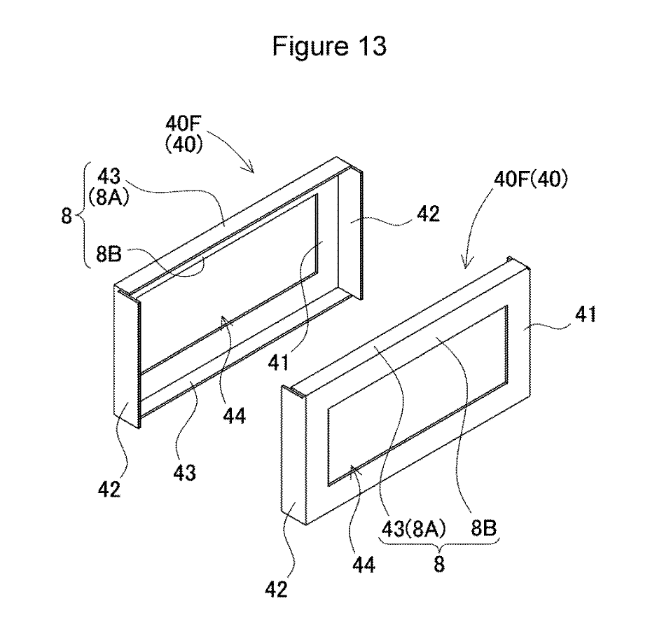

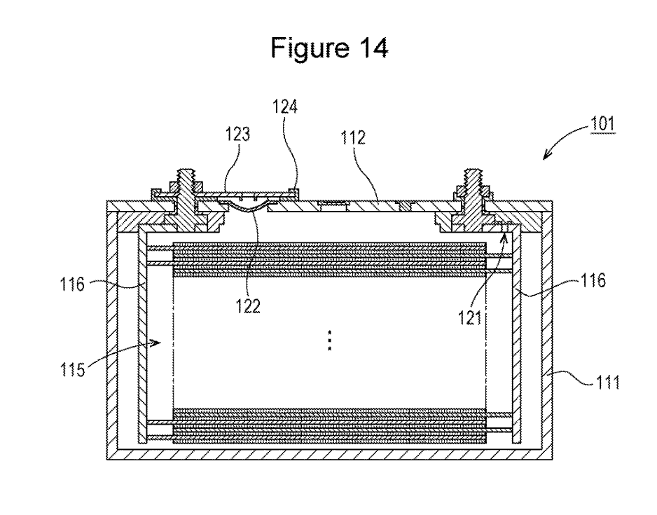

Further, in the binding members 4, the body portions 41 covering the side surfaces of the battery stack 5 can have open windows. In bind bars 40E and 40F illustrated in FIGS. 12 and 13, body portions 41 covering side surfaces of a battery stack 5 have open windows 44 in center portions thereof. The illustrated open windows 44 are open to be opposed to intermediate portions of the side surfaces of the battery stack 5 except for upper portions and lower portions.

In the bind bars 40E of FIG. 10, connecting pieces 42 are provided at both ends of each of the body portions 41 having the open windows 44 in the center portions, and horizontal portions 43 covering the upper surface of the battery stack are provided at upper ends of the body portions 41. In the bind bars 40E, the body portions 41 are frame-shaped, and upper parts of the body portions 41 and the horizontal portions 43 function as protective cover portions 8 that cover upper end corner portions 1T of secondary batteries 1.

In the bind bars 40F of FIG. 11, connecting pieces 42 are provided at both ends of each of the body portions 41 having the open windows 44 in center portions thereof, and horizontal portions 43 covering an upper surface and a lower end of the battery stack are provided at upper ends and lower ends of the body portions 41. In the bind bars 40F, the body portions 41 are also frame-shaped, and upper parts of the body portions 41 and the horizontal portions 43 at the upper ends function as protective cover portions 8 that cover upper end corner portions 1T of secondary batteries 1.

Since these bind bars 40E and 40F have the open windows 44, the weight and cost of the bind bars 40E and 40F are reduced. Further, heat can be efficiently dissipated from the secondary batteries by exposing the side surfaces of the battery stack from the open windows 44. Although not illustrated, in particular, in an air-cooled power supply device that cools secondary batteries by forcibly blowing cooling air between the secondary batteries, the cooling air can be passed and blown through the open windows provided as ventilations in the bind bars.

The above-described power supply devices can be used as a vehicle-mounted power supply. As vehicles in which the power supply device is mounted, electrically driven vehicles, such as a hybrid car and a plug-in hybrid car that run by using both an engine and a motor and an electric car that runs by using only a motor can be used. The power supply device is used as a power supply for these vehicles.

The embodiments and examples of the present invention have been described above with reference to the drawings. However, the above-described embodiments and examples are just illustrative examples for embodying the technical idea of the present invention, and the present, invention is not limited to the above embodiments and examples. This description does not specify the members in the scope of the claims to the members in the embodiments. In the above description, the same names and symbols denote the same or equivalent members, and detailed descriptions thereof are appropriately omitted. Further, in the elements that constitute the present invention, a plurality of elements may be constituted by the same member so that one member functions as a plurality of elements. Conversely, the function of one member may be shared and realized by a plurality of members.

### INDUSTRIAL APPLICABILITY

The power supply device and the vehicle including the power supply device according to the present invention can be suitably used as a power supply device for, for example, a plug-in hybrid electric car and a hybrid electric car capable of switching an EV running mode and an HEV running mode and an electric car. The power supply device can be appropriately used for applications as a backup power supply device mountable in a computer server rack, a backup power supply device for a wireless base station of, for example, a mobile phone, a power storage device used in combination with a solar battery, such as a domestic or factory storage power supply or a power supply of a street light, and a backup power supply of a traffic light.

### REFERENCE SIGNS LIST

100 power supply device
1 secondary battery
1A upper surface
1B side surface
1C bottom surface
1X principal surface
1T upper end corner portion
2 separator
3 end plate
4 binding member
5 battery stack
6 bus bar
7 current interrupt device
8 protective cover portion
8A upper-surface covering part
8B side-surface covering part
10 assembled battery
11 outer can
12 sealing plate
12A short-circuit hole
13 electrode terminal
13A first electrode terminal
13B second electrode terminal
14 gas discharge valve
15 electrode body
16 collector member
16A platelike portion
17 gasket
18 fixed member
19 liquid injection portion
20 short-circuit part
21 fuse part
21A fuse hole
21B connecting portion
22 inverting plate
23 connection plate
24 insulating portion
25 welded portion
45 insulating member
40, 40A, 40B, 40C, 40D, 40E, 40F bind bar
40X upper bind bar
40Y, 40Z lower bind bar
41 body portion
42 connecting piece
43 horizontal portion
44 open window
45 insulating member
70 outer case
71 lower case
72 upper case
73 end face plate
74 flange
101 secondary battery
111 outer can
112 sealing plate
115 electrode body
116 collector plate
121 fuse part
122 inverting plate
123 connection plate
124 insulating member

1. A power supply device comprising:
a battery stack in which a plurality of secondary batteries are stacked; and
a binding member that binds the battery stack,
wherein each of the secondary batteries includes
an electrode body having a positive electrode and a negative electrode,
an outer can having an opening and shaped like a bottomed cylinder to contain the electrode body,
a sealing plate that closes the opening of the outer can,
a pair of electrode terminals disposed on the sealing plate, and
a current interrupt device,
wherein the pair of electrode terminals include a first electrode terminal insulated from the sealing plate and a second electrode terminal electrically connected to the sealing plate, and are electrically connected to the electrode body through a collector member inside the secondary battery,
wherein the current interrupt device includes a short-circuit part that short-circuits the first electrode terminal and the sealing plate when an internal pressure of the secondary battery exceeds a set pressure, and a &se part provided in the collector member.
wherein the fuse part is disposed close to an upper end corner portion as a boundary portion between an upper surface Mid a side surface of the secondary battery, and is fused by an overcurrent in a short-circuit state of the short-circuit part,
wherein the binding member includes a protective cover portion located on each side of the battery stack to cover the upper end corner portion of the secondary battery, and
wherein the protective cover portion includes an upper-surface covering part that covers an upper surface of the upper end corner portion and a side-surface covering part that covers a side surface of the upper end corner portion.

2. The power supply device according to claim 1, wherein the binding member is a bind bar formed by bending a metal plate having a predetermined thickness.

3. The power supply device according to claim 2, wherein an insulating member is provided on an inner surface of the bind bar.

4. The power supply device according to claim 2,
wherein the bind bar includes an upper bind bar that covers an upper portion of a side surface of the battery stack and a lower bind bar that covers a lower portion of the side surface of the battery stack, and
wherein the upper bind bar also functions as the protective cover portion.

5. The power supply device according to claim 2, wherein the bind bar has a body portion opposed to a side surface of the battery stack, and the body portion covers the entire side surface of the battery stack.

6. The power supply device according to claim 2, wherein the bind bar has a body portion opposed to a side surface of the battery stack, and the body portion has an open window.

7. The power supply device according to claim 2, wherein the bind bar has a horizontal portion that covers at least a part of a bottom surface of the battery stack.

8. A vehicle comprising the power supply device according to claim 1.
